(19) United States
(12) Patent Application Publication
(10) Pub. No.: US 2026/0321461 A1
(43) Pub. Date: Oct. 15, 2026

(54) BUSBAR MODULE

(71) Applicant: Yazaki Corporation, Tokyo (JP)

(72) Inventors: Shinichi Yanagihara, Shizuoka (JP); Hideki Inoue, Shizuoka (JP)

(73) Assignee: Yazaki Corporation, Tokyo (JP)

(21) Appl. No.: 19/557,284

(22) Filed: Mar. 5, 2026

(30) Foreign Application Priority Data
Apr. 11, 2025 (JP) 2025-065401

(51) Int. Cl. H01B 7/40; H01B 7/00; H01B 17/16

(52) U.S. Cl. CPC H01B 7/40; H01B 7/0009; H01B 17/16

(57) ABSTRACT

A busbar module includes a conductive busbar formed in a flat strip shape and extending in a routing direction; a tubular exterior member formed in a tubular shape, through which the busbar is inserted; and a first cover member and a second cover member combined while being opposed in a assembling direction, and hold in between the exterior member having the busbar inserted therein. The first cover member includes a rib that protrudes, in an assembled state, from an opposing face facing the exterior member towards the exterior member, and presses the exterior member towards the busbar to cause elastic deformation. The rib includes a plurality of straight portions formed in a straight shape, and a connection portion where adjacent straight portions are connected at a predetermined angle, when viewed from the second cover member in the assembled state.

### CROSS-REFERENCE TO RELATED APPLICATION (S)

The present application claims priority to and incorporates by reference the entire contents of Japanese Patent Application No. 2025-065401 filed in Japan on Apr. 11, 2025.

### BACKGROUND OF THE INVENTION

### 1. Field of the Invention

The present invention relates to a busbar module.

### 2. Description of the Related Art

Conventional busbar modules include an inter-stack routing module that employs routing between stacks. For example, the busbar module has a busbar formed in a flat strip shape, an exterior that protects the busbar, and a cover member that immobilizes the exterior with respect to the busbar. For the purpose of protecting the busbar from high heat or the like, the exterior has employed a sleeve-like protector that excels in heat resistance and fire resistance.

For example, Japanese Patent Application Laid-open No. JP 2019-009090 A has disclosed an article having a plate-like conductor body, and a heat absorber attached to the conductor body at a center positioned between a pair of electrical connection parts, and having a heat capacity larger than that of the conductor body, for the purpose of protecting the busbar from high heat or the like.

In the aforementioned busbar module, the exterior member is immobilized with respect to the busbar by holding the exterior member between the pair of cover members. This, however, leaves a room for improvement, since the exterior member could be displaced in the routing direction of the busbar.

### SUMMARY OF THE INVENTION

It is therefore an object of the present invention to provide a busbar module capable of suppressing the exterior member having the busbar inserted therein, from being displaced in the routing direction.

In order to achieve the above mentioned object, a busbar module according to one aspect of the present invention includes a conductive busbar formed in a flat strip shape and extending in a routing direction; an exterior member formed in a tubular shape, through which the busbar is inserted; and a first cover member and a second cover member combined while being opposed in a assembling direction that crosses the routing direction, and hold in between the exterior member, having the busbar inserted therein in the assembling direction, wherein the first cover member includes a rib that protrudes, in an assembled state, from an opposing face facing the exterior member towards the exterior member, and presses the exterior member towards the busbar to cause elastic deformation, and the rib includes a plurality of straight portions formed in a straight shape, and a connection portion where adjacent straight portions are connected at a predetermined angle, when viewed from the second cover member in the assembled state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic structure of a busbar module according to an embodiment;

FIG. 2 is a perspective view illustrating a schematic structure of a first cover member in the busbar module according to the embodiment;

FIG. 3 is a plan view illustrating a schematic structure of the first cover member according to the embodiment;

FIG. 4 is a partially enlarged view illustrating an essential part of the first cover member according to the embodiment;

FIG. 5 is a plan view illustrating a schematic structure of a first cover member according to a first modified example of the embodiment;

FIG. 6 is a partially enlarged view illustrating an essential part of the first cover member according to the first modified example of the embodiment;

FIG. 7 is a plan view illustrating a schematic structure of a first cover member according to a second modified example of the embodiment; and

FIG. 8 is a partially enlarged view illustrating an essential part of the first cover member according to the second modified example of the embodiment.

### DESCRIPTION OF THE PREFERRED EMBODIMENTS

Embodiments according to the present invention will be described in detail with reference to the drawings. The present invention is by no means limited by the following embodiments. That is, constituents in the following embodiments include those that can be easily assumed by those skilled in the art or those that are substantially the same, to which various omissions, substitutions, and changes are applicable without departing from the gist of the invention.

### Embodiment

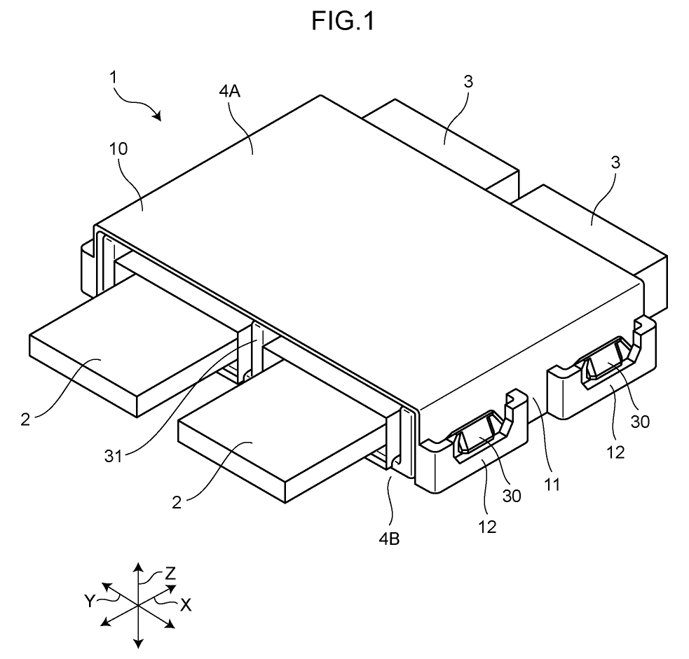

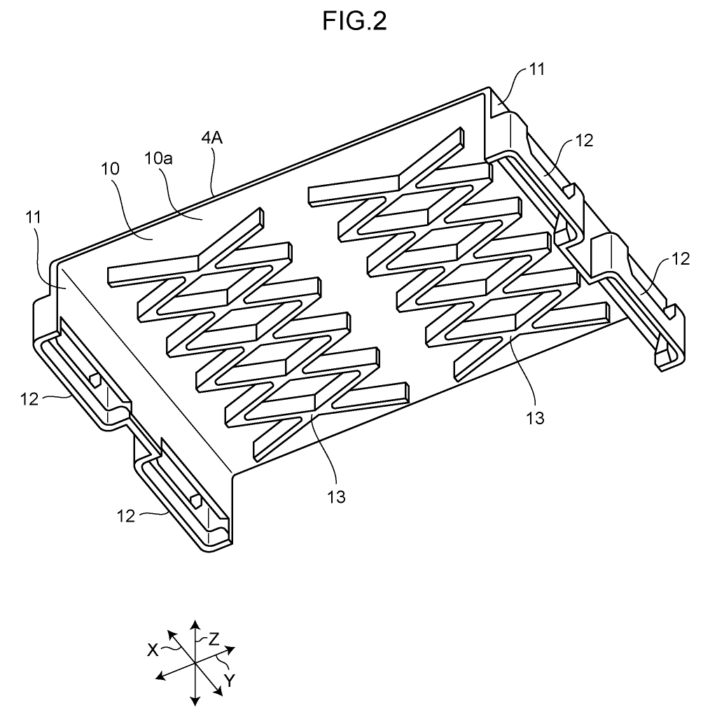

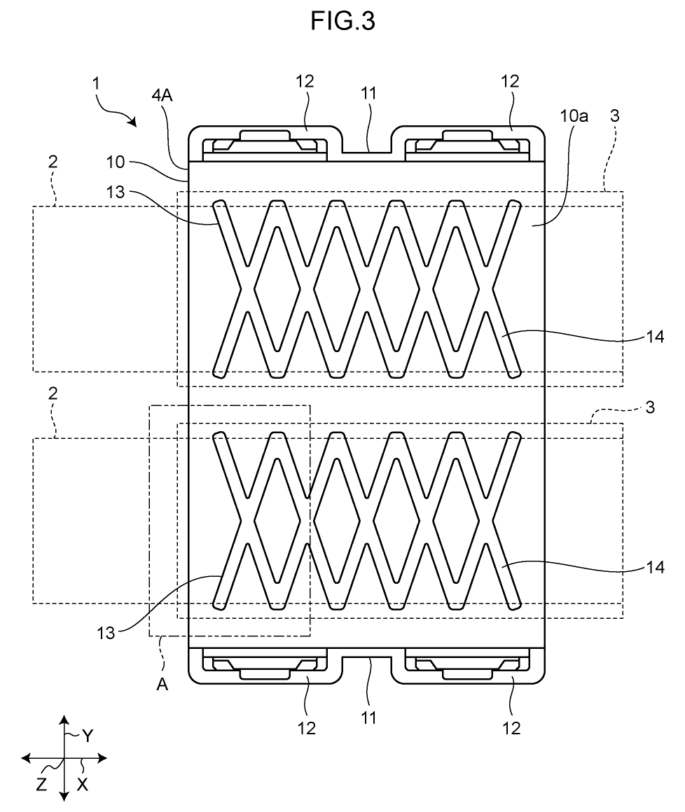

FIG. 1 is a perspective view illustrating a schematic structure of a busbar module according to an embodiment, FIG. 2 is a perspective view illustrating a schematic structure of a first cover member in the busbar module according to the embodiment, and FIG. 3 is a plan view illustrating a schematic structure of the first cover member according to the embodiment. Note that FIG. 3 illustrates a busbar 2 and an exterior member 3 with broken lines, with a second cover member 4B omitted. A busbar module 1 illustrated in FIG. 1 is, for example, an inter-stack routing module routed between stacks of high voltage batteries (an assembly of single batteries (cells) stacked therein) for driving vehicles. The busbar module 1 of this embodiment has the busbar 2, the exterior member 3, a first cover member 4A, and the second cover member 4B.

In the following description, the illustrated X-direction is defined to be a "routing direction X", the Y-direction to be a "width direction Y", and the Z-direction to be an "assembling direction Z". The routing direction X, the width direction Y, and the assembling direction Z are orthogonal to each other. The routing direction X corresponds to a routing direction of the busbar 2 and an extending direction of the exterior member 3. The width direction Y corresponds to a direction along the width of the busbar 2. The assembling direction Z corresponds to a direction in which the first cover member 4A is assembled to the second cover member 4B. The individual directions used in the following description indicate directions which are defined in a state where the individual components are mutually assembled, unless otherwise specified.

The busbar 2 is a member made of a conductive material, formed in a flat strip shape, and extending in the routing direction X. Both ends, in the routing direction X, of the busbar 2 are individually connected to different stacks, although not illustrated.

The exterior member 3 is a heat resistant soft tube formed in a tubular shape, into which the busbar 2 is inserted. The exterior member 3 is made of an insulating material having relatively high heat resistance and fire resistance, and protects the busbar 2 from high heat or flame. The exterior member 3 is constituted, for example, by a sleeve knitted with glass fiber, and having a silicon coating on the exterior. The exterior member 3 is designed, for example, to have a shrinkage rate not exceeding 10%, and relatively high flexibility.

The first cover member 4A and the second cover member 4B are combined while being opposed in a assembling direction Z that crosses the routing direction X, and hold in between the exterior member 3 having the busbar 2 inserted therein, in the assembling direction Z. The first cover member 4A is a so-called upper cover, meanwhile the second cover member 4B is a so-called lower cover. Both the first cover member 4A and the second cover member 4B are made of an insulating synthetic resin material or the like, and are formed in a gutter shape. The first cover member 4A and the second cover member 4B are mutually locked, with a locking structure described later.

The first cover member 4A has, as illustrated in FIG. 2, a cover body 10, a pair of cover sidewalls 11, four locking holes 12, and a rib 13. Note that the second cover member 4B will not be detailed since the shape is nearly equal to that of the first cover member 4A, although there are differences in that the second cover member 4B has four locking claws 30 in place of the four locking holes 12, and has a partition wall 31 that is disposed upright at the center in the width direction Y of the cover body 10 and extends in the routing direction X.

The cover body 10 is formed in a flat plate shape, and has cover sidewalls 11 at both ends in the width direction Y. The cover body 10 is formed in a rectangular shape as viewed in the assembling direction Z. The cover body 10 has an opposing face 10a, which faces the exterior member 3 in an assembled state of the first cover member 4A and the second cover member 4B combined while being opposed in the assembling direction Z. The opposing face 10a has two ribs 13 formed thereon, arranged at an interval in the width direction Y.

The pair of cover sidewalls 11 are formed so as to rise up from each end in the width direction Y of the cover body 10, towards one side in the assembling direction Z. The pair of cover sidewalls 11 are opposed in the width direction Y, with the cover body 10 placed in between. Each cover sidewall 11 is formed in a rectangular shape as viewed in the width direction Y, with the long side aligned in the routing direction X, and with the short side aligned in the assembling direction Z.

Each locking hole 12 constitutes a locking structure together with the locking claw 30 provided to the second cover member 4B, and is hooked on the locking claw 30 to fix the first cover member 4A to the second cover member 4B. The locking holes 12 are provided to each cover sidewall 11, at two places spaced in the routing direction X.

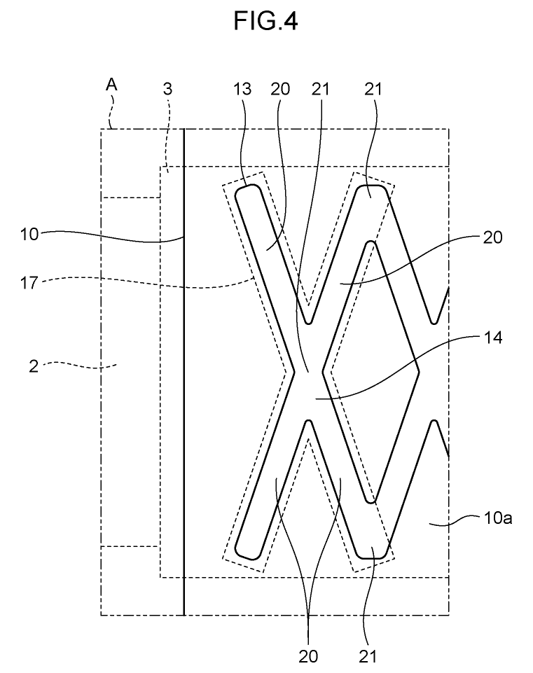

The rib 13 is a part as indicated by frame A illustrated in FIG. 3 and FIG. 4, that protrudes, in an assembled state of the first cover member 4A and the second cover member 4B combined while being opposed in the assembling direction Z, from the opposing face 10a facing the exterior member 3, towards the exterior member 3, and presses the exterior member 3 towards the busbar 2 to cause elastic deformation. The rib 13 has a plurality of straight portions 20 and connection portions 21 connecting the adjacent straight portions 20, rather than being formed simply in a straight shape. The rib 13 has a plurality of straight portions 20 formed in a straight shape, and a connection portion 21 where adjacent straight portions 20 are connected at a predetermined angle, when viewed from the second cover member 4B in the assembled state of the first cover member 4A and the second cover member 4B combined while being opposed in the assembling direction Z. The height of the rib 13 in the assembling direction Z is relatively lower than the height of the cover sidewalls 11 in the assembling direction Z.

When viewed from the second cover member 4B in the assembled state of the first cover member 4A and the second cover member 4B combined while being opposed in the assembling direction Z, the rib 13 has X-shaped portions 17 each being formed in an X-shape by linking four of the straight portions 20, with one connection portion 21 positioned at the center. The X-shaped portions 17 are arranged in the routing direction X, with the end portions in the width direction Y of the adjacent X-shaped portions 17 linked to each other. The rib 13 has a rib end face 14 that abuts on the exterior member 3 and presses the exterior member 3 towards the busbar 2, in the assembled state. The rib end face 14 is formed substantially flat.

Next, a method of assembling the busbar module 1 will be briefly explained. First, an assembler passes the busbar 2 through the tubular exterior member 3. Next, the assembler places the exterior member 3 having the busbar 2 inserted therein, on the second cover member 4B. The assembler then puts the first cover member 4A on the second cover member 4B, and presses the first cover member 4A in the assembling direction Z, to press-fit the rib 13 of the first cover member 4A into the exterior member 3. Next, the assembler hooks the first cover member 4A onto the second cover member 4B to make up the busbar module 1. The busbar module 1 is routed between the stacks.

In the conventional busbar module, with use of the first cover member 4A having no rib 13, the exterior member 3 in the assembled state has been suppressed from being displaced in the routing direction X, with the aid of surface contact between the individual inner circumferential faces of the pair of cover members that hold in between the exterior member, and the outer circumferential face of the exterior member 3. The obtainable surface pressure, exerted from the cover members on the exterior member, has however not been sufficient.

Now, the busbar module 1 of this embodiment, with use of the first cover member 4A having the rib 13, allows the rib end face 14 to be pressed onto the exterior member 3, thus making an effect of relatively increasing the surface pressure of the rib 13 exerted on the exterior member 3. This makes the busbar module 1 possible to suppress displacement, in the routing direction, of the exterior member 3 having the busbar 2 inserted therein, as compared with the conventional busbar module.

In the busbar module 1 of this embodiment, the rib 13 has a plurality of straight portions 20 formed in a straight shape, and a connection portion 21 where adjacent straight portions 20 are connected at a predetermined angle, when viewed from the second cover member 4B in the assembled state. This makes the busbar module 1 possible to keep a sufficient contact area of the rib end face 14 with the exterior member 3, as compared, for example, with a rib having a simple shape (such as a shape composed only of the straight portions 20).

In the busbar module 1 of this embodiment, the rib 13, when viewed from the second cover member 4B in the assembled state, has the X-shaped portions 17 formed in an X shape, and the X-shaped portions 17 are arranged in the routing direction X, with the end portions in the width direction Y of the adjacent X-shaped portions 17 linked to each other. As a result, the busbar module 1 can increase the amount of consumption of a synthetic resin for forming the first cover member 4A, and improve rigidity of the first cover member 4A, as compared with the conventional busbar module.

As described above, the busbar module 1 according to this embodiment has the busbar 2; the tubular exterior member 3 through which the busbar 2 is inserted; and the first cover member 4A and the second cover member 4B that hold in between the exterior member 3 having the busbar 2 inserted therein in the assembling direction Z, in the assembled state. The first cover member 4A has the rib 13 that presses the exterior member 3 towards the busbar 2, thereby elastically deforming the exterior member 3. The rib 13 has a plurality of straight portions 20 formed in a straight shape, and a connection portion 21 where adjacent straight portions 20 are connected at a predetermined angle, when viewed from the second cover member 4B in the assembled state. As a result, the busbar module 1 can suppress displacement, in the routing direction X, of the exterior member 3 having the busbar 2 inserted therein, as compared with the conventional busbar module.

### First Modified Example

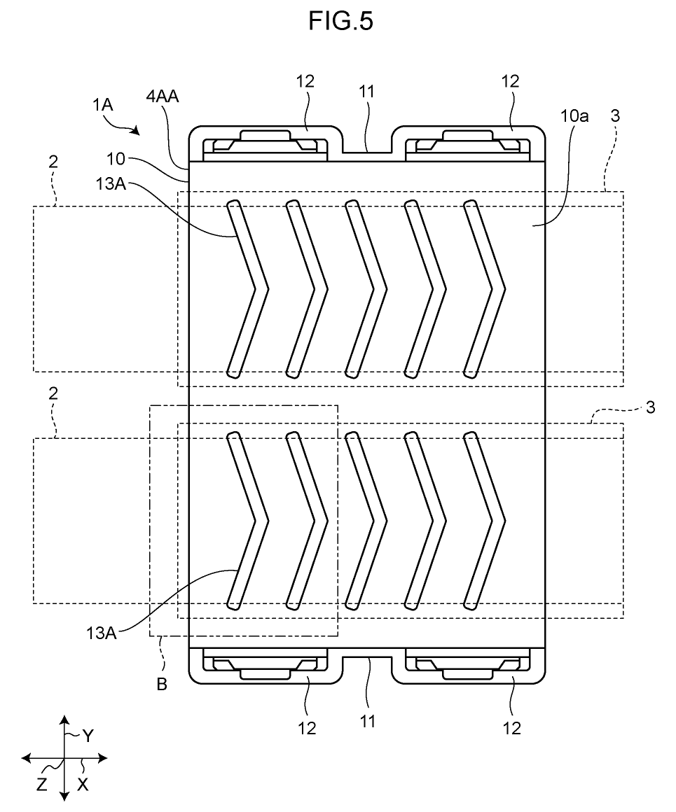

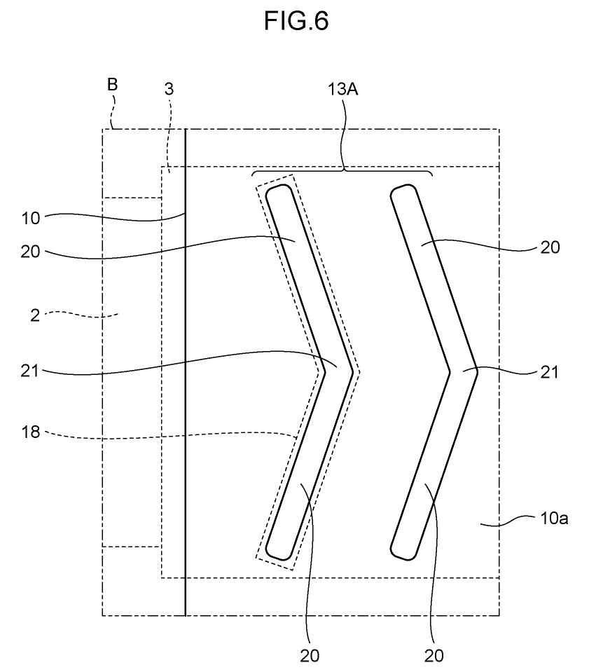

FIG. 5 is a plan view illustrating a schematic structure of a first cover member according to a first modified example of the embodiment, and FIG. 6 is a partially enlarged view illustrating an essential part of the first cover member according to the first modified example of the embodiment. Note that FIG. 5 illustrates the busbar 2 and the exterior member 3 with broken lines, with the second cover member 4B omitted. FIG. 6 is an enlarged view of a portion surrounded by frame B indicated in FIG. 5.

A busbar module 1A according to the first modified example of the embodiment has the same structure as the busbar module 1 of the aforementioned embodiment, from which the same operation and effect as those in the aforementioned embodiment ascribed to such same structure are obtainable.

In the busbar module 1A, a first cover member 4AA has a rib 13A, as illustrated in FIG. 5. The rib 13A has a plurality of straight portions 20 formed in a straight shape, and a connection portion 21 where adjacent straight portions 20 are connected at a predetermined angle, when viewed from the second cover member 4B in the assembled state.

More specifically as illustrated in FIG. 6, the rib 13A according to the first modified example, when viewed from the second cover member 4B in the assembled state, has V-shaped portions 18 each being formed in a V-shape by linking two of the straight portions 20, with one connection portion 21 positioned at the apex, and the V-shaped portions 18 are arranged at intervals in the routing direction X. Both the two straight portions 20 are arranged in a direction that crosses the width direction Y, when viewed from the assembling direction Z. The individual apexes of the plurality of V-shaped portions 18 are arranged, but not restrictively, towards one side in the routing direction X. Also note that the position and the number of the plurality of V-shaped portions 18 are not limited to those in the illustrated example.

### Second Modified Example

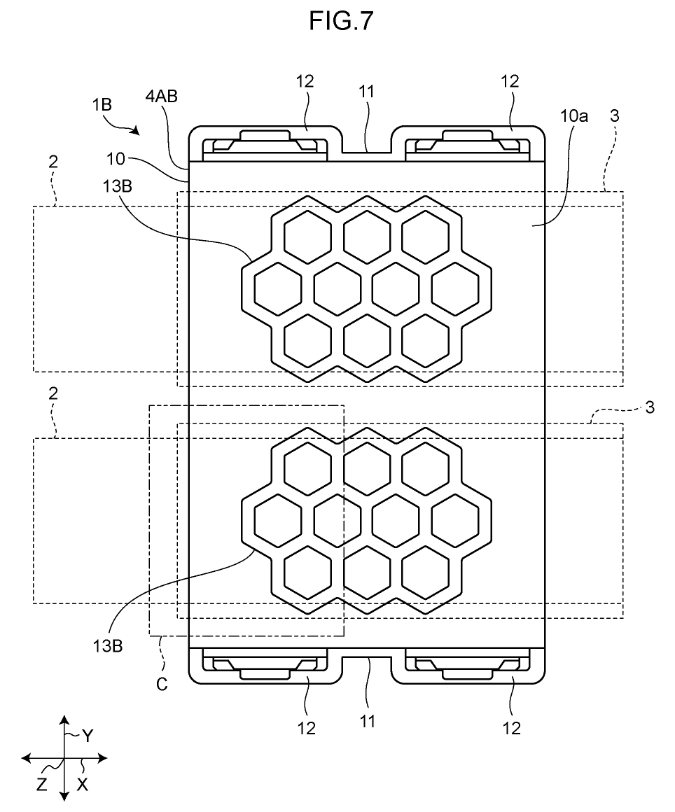

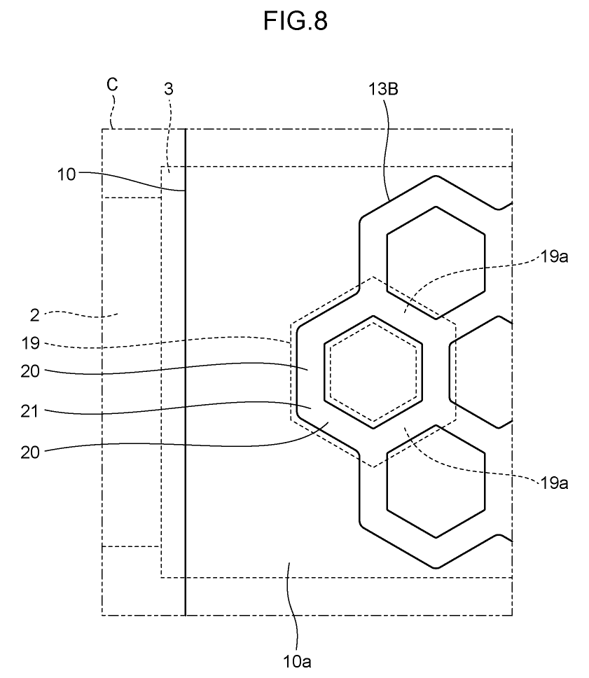

FIG. 7 is a plan view illustrating a schematic structure of the first cover member according to a second modified example of the embodiment, and FIG. 8 is a partially enlarged view illustrating an essential part of the first cover member according to the second modified example of the embodiment. Note that FIG. 7 illustrates the busbar 2 and the exterior member 3 with broken lines, with the second cover member 4B omitted. FIG. 8 is an enlarged view of a portion surrounded by frame C indicated in FIG. 7.

A busbar module 1B according to the second modified example of the embodiment has the same structure as the busbar module 1 of the aforementioned embodiment, from which the same operation and effect as those in the aforementioned embodiment ascribed to such same structure are obtainable.

In the busbar module 1B, a first cover member 4AB has a rib 13B, as illustrated in FIG. 7. The rib 13B has a plurality of straight portions 20 formed in a straight shape, and a connection portion 21 where adjacent straight portions 20 are connected at a predetermined angle, when viewed from the second cover member 4B in the assembled state.

More specifically as illustrated in FIG. 8, the rib 13B according to the second modified example, when viewed from the second cover member 4B in the assembled state, has polygonal portions 19 each being formed by linking a plurality of straight portions 20 with connection portions 21, with sides 19a shared by the adjacent polygonal portions 19. Each polygonal portion 19 is formed in regular hexagon for example, but not restrictively. Also note that the position and the number of the plurality of polygonal portions 19 are not limited to those in the illustrated example.

Although three forms of ribs 13, 13A and 13B as illustrated have been described in the aforementioned embodiment, and in the first and second modified examples, the rib is not limited thereto. For example, when viewed from the second cover member 4B in the assembled state, the rib may have a plurality of straight portions 20 (referred to as "first straight portion group") arranged in the width direction Y, as well as in the routing direction X at intervals, a plurality of straight portions 20 (referred to as" second straight portion group") arranged linearly in a direction that crosses the routing direction X, and a plurality of connection portions 21 that connect the first straight portion group and the second straight portion group.

The ribs 13, 13A, and 13B, all formed on the first cover member 4A but not limitedly, may alternatively be formed on the second cover member 4B. The ribs 13, 13A, and 13B may alternatively be formed on both the first cover member 4A and the second cover member 4B.

The busbar module according to this embodiment may be structured by appropriately combining the constituents of the aforementioned embodiment, and the first and second modified examples.

The busbar module according to the present embodiment can make an effect of suppressing the exterior member having the busbar inserted therein, from being displaced in the routing direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar module comprising:
a conductive busbar formed in a flat strip shape and extending in a routing direction;
an exterior member formed in a tubular shape, through which the busbar is inserted; and
a first cover member and a second cover member combined while being opposed in a assembling direction that crosses the routing direction, and hold in between the exterior member, having the busbar inserted therein in the assembling direction, wherein
the first cover member includes a rib that protrudes, in an assembled state, from an opposing face facing the exterior member towards the exterior member, and presses the exterior member towards the busbar to cause elastic deformation, and
the rib includes a plurality of straight portions formed in a straight shape, and a connection portion where adjacent straight portions are connected at a predetermined angle, when viewed from the second cover member in the assembled state.

2. The busbar module according to claim 1, wherein
when viewed from the second cover member in the assembled state, the rib includes X-shaped portions each being formed in an X-shape by linking four of the straight portions, with one connection portion positioned at the center, and
the X-shaped portions are arranged in the routing direction, with the end portions in a width direction of the adjacent X-shaped portions linked to each other.

3. The busbar module according to claim 1, wherein
when viewed from the second cover member in the assembled state, the rib includes V-shaped portions each being formed in a V-shape by linking two of the straight portions, with one connection portion positioned at the apex, and
the V-shaped portions are arranged at an interval in the routing direction.

4. The busbar module according to claim 1, wherein
when viewed from the second cover member in the assembled state, the rib includes polygonal portions each being formed by linking a plurality of straight portions with connection portions, with sides shared by the adjacent polygonal portions.
